(19) United States
(12) Patent Application Publication
(10) Pub. No.: US 2007/0008278 A1
(43) Pub. Date: Jan. 11, 2007

(54) Electrophoretic display unit

(75) Inventors: Mark Thomas Johnson, Eindhoven (NL); Masaru Yasui, Kobe (JP); Guofu Zhou, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/574,148

(22) PCT Filed: Sep. 28, 2004
(86) PCT No.: PCT/IB04/51887

§ 371 Date: Mar. 29, 2006

Related U.S. Application Data
(60) Provisional application No. 60/508,496, filed on Oct. 3, 2003.

(51) Int. Cl. G09G 3/34

(52) U.S. Cl. 345/107

(57) ABSTRACT

Electrophoretic display units (100) comprising pixels (11) situated between a common electrode (6) and pixel electrodes (5) need, for shortening the total image update times, increased driving voltages across the pixels (11) which make disturbances more visible. To camouflage such disturbances, instead of one common electrode (6), different counter electrodes (16,17) coupled to different portions (66,67) of the electrophoretic display panel (60) are introduced. First and second counter electrodes (16,17) receive first and second voltage signals (V₁₆, V₁₇) lik˜ alternating voltage signals having opposite phases. First shaking data pulses (V₁₆-V_{E1}, V₁₆-V_{E3}) are supplied to the first portion (66) and second shaking data pulses (V₁₇-V_{E2}, V₁₇-V_{E4}) are supplied to the second portion (67), which first and second shaking data pulses have opposite amplitudes. Setting signals (S₁,S₂,S₃,S₄) supplied during setting frame period (F_{S}) reduce voltage swings at pixel electrodes (5).

The invention relates to an electrophoretic display unit, to a display device, to a method for driving an electrophoretic display unit, and to a processor program product for driving an electrophoretic display unit.

Examples of display devices of this type are: monitors, laptop computers, personal digital assistants (PDAs), mobile telephones and electronic books, electronic newspapers, and electronic magazines.

A prior art electrophoretic display unit is known from WO 99/53373, which discloses an electronic ink display comprising two substrates, with one of the substrates being transparent and having a common electrode (also known as counter electrode) and with the other substrate being provided with pixel electrodes arranged in rows and columns. A crossing between a row and a column electrode is associated with a pixel. The pixel is formed between a part of the common electrode and a pixel electrode. The pixel electrode is coupled to the drain of a transistor, of which the source is coupled to the column electrode or data electrode and of which the gate is coupled to the row electrode or selection electrode. This arrangement of pixels, transistors and row and column electrodes jointly forms an active matrix. A row driver (select driver) supplies a row driving signal or a selection signal for selecting a row of pixels and the column driver (data driver) supplies column driving signals or data signals to the selected row of pixels via the column electrodes and the transistors. The data signals correspond to data to be displayed, and form, together with the selection signal, a (part of a) driving signal for driving one or more pixels.

Furthermore, an electronic ink is provided between the pixel electrode and the common electrode provided on the transparent substrate. The electronic ink comprises multiple microcapsules with a diameter of about 10 to 50 microns. Each microcapsule comprises positively charged white particles and negatively charged black particles suspended in a fluid. When a positive voltage is applied to the pixel electrode, the white particles move to the side of the microcapsule directed to the transparent substrate, and the pixel becomes visible to a viewer. Simultaneously, the black particles move to the pixel electrode at the opposite side of the microcapsule where they are hidden from the viewer. By applying a negative voltage to the pixel electrode, the black particles move to the common electrode at the side of the microcapsule directed to the transparent substrate, and the pixel appears dark to a viewer. Simultaneously, the white particles move to the pixel electrode at the opposite side of the microcapsule where they are hidden from the viewer. When the electric voltages are removed, the display unit remains in the acquired state and exhibits a bistable character.

To reduce the dependency of the optical response of the electrophoretic display unit on the history of the pixels, preset data signals are supplied before the data-dependent signals are supplied. These preset data signals comprise data pulses representing energies which are sufficient to release the electrophoretic particles from a static state at one of the two electrodes, but which are too low to allow the electrophoretic particles to reach the other one of the electrodes. Because of the reduced dependency on the history of the pixels, the optical response to identical data will be substantially equal, regardless of the history of the pixels.

The time-interval required for driving all pixels in all rows once (by driving each row one after the other and by driving all columns simultaneously once per row) is called a frame. Per frame, each data pulse for driving a pixel requires, per row, a row driving action for supplying the row driving signal (the selection signal) to the row for selecting (driving) this row, and a column driving action for supplying the data pulse, like for example a data pulse of the preset data signals or a data pulse of the data-dependent signals, to the pixel. Usually, the latter is done for all pixels in a row simultaneously.

When updating an image, firstly a number of data pulses of the preset data signals are supplied, further to be called preset data pulses. Each preset data pulse has a duration of one frame period. The first preset data pulse, for example, has a positive amplitude, the second one a negative amplitude, and the third one a positive amplitude etc. Such preset data pulses with alternating amplitudes do not change the gray value displayed by the pixel.

During one or more subsequent frames, the data-dependent signals are supplied, with a data-dependent signal having a duration of zero, one, two to for example fifteen frame periods. Thereby, a data-dependent signal having a duration of zero frame periods, for example, corresponds with the pixel displaying full black assuming that the pixel already displayed full black. In case the pixel displayed a certain gray value, this gray value remains unchanged when the pixel is driven with a data-dependent signal having a duration of zero frame periods, in other words when being driven with a driving data pulse having a zero amplitude. A data-dependent signal having, for example, a duration of fifteen frame periods comprises fifteen driving data pulses and results in the pixel displaying full white, and a data-dependent signal having a duration of one to fourteen frame periods, for example, comprises one to fourteen driving data pulses and results in the pixel displaying one of a limited number of gray values between full black and full white.

Each one of these pulses has a width and a height. The product of width and height represents the energy of this pulse. Due to a certain energy being necessary for a certain driving action, per certain driving action, the required energy must be equal to or exceed a minimum value.

To get shorter image update times for updating images to be displayed by an electrophoretic display unit, or in other words, to increase the driving speed of an electrophoretic display unit, the width of one or more pulses is to be minimized. To get the required energy per pulse, the height of these pulses is then to be increased, in other words the voltage amplitudes of these pulses for driving the pixels are then to be increased.

According to a first option, to increase the height of the pulses across the pixels, the standard data driver is to be adapted or is to be replaced by an other data driver. Due to the common electrode being coupled to ground, an adapted or an other data driver must be able to supply pulses having a larger height. Such an adapted or an other data driver is however expensive. According to a second option, when using the same standard data driver, the height of the pulses across the pixels is increased by supplying a non-zero, alternating voltage signal to the common electrode. Thereto, when driving the pixels with positive data pulses, the common electrode should be at a negative voltage level, and when driving the pixels with negative data pulses, the common electrode should be at a positive voltage level. As a result, larger voltage amplitudes are present across the pixels.

The known electrophoretic display unit is disadvantageous, inter alia, as larger amplitudes of the preset data pulses become visible on the screen as a disturbance in the form of a flickering image.

It is an object of the invention, inter alia, of providing an electrophoretic display unit with a relatively low the visibility of these disturbances.

The invention is defined by the independent claims. The dependent claims define advantageous embodiments.

The electrophoretic display unit according to the invention comprises

an electrophoretic display panel comprising pixels;

a first counter electrode coupled to pixels in a first portion of the electrophoretic display panel;

a second counter electrode coupled to pixels in a second portion of the electrophoretic display panel; and

a controller for controlling a supply of a first signal to the first counter electrode and a supply of a second signal different from said first voltage signal, to the second counter electrode.

By introducing the first counter electrode coupled to the first portion comprising first pixels and a second counter electrode coupled to the second portion comprising second pixels, instead of having one common electrode for all pixels, the electrophoretic display unit is divided into at least two portions, with each portion having its own counter electrode. The supply of different voltage signals to the different counter electrodes allows the more individual control of the individual portions. As a result, instead of one kind of disturbance for the entire electrophoretic display unit, each portion has its own kind of disturbance. The average of several kinds of disturbances is less disturbing than each single kind of disturbance, resulting in reduced visibility of the disturbances.

It should be noted that the visibility of disturbances can alternatively be reduced by increasing a frame rate. This however leads to a disadvantageous increase of power consumption. The introduction of different counter electrodes for different portions keeps the power consumption of the electrophoretic display unit at substantially the same level.

An embodiment of an electrophoretic display unit according to the invention is defined by the first and second voltage signals being alternating voltage signals having substantially opposite phases. This allows the use of preset data pulses having first increased alternating amplitudes in the first portion and second increased alternating amplitudes in the second portion, which first and second increased alternating amplitudes are opposite with respect to each other. In this way the visibility of the disturbances is further reduced.

An embodiment of an electrophoretic display unit according to the invention is defined by further comprising data driving circuitry for supplying a data pulse to a pixel electrode of a pixel via a switching element, the controller being adapted to control the data driving circuitry for supplying a setting signal to the pixel electrode for reducing a voltage across the pixel before a transition of at least one of the first and second voltage signals. By supplying the setting signal to the pixel electrode, the pixel electrode is set to a predefined voltage. For example, in case of a positive transition in the alternating voltage signal, the voltage across the pixel is reduced by setting the pixel electrode to a lower voltage or a negative voltage before the positive transition. In case of a negative transition in the alternating voltage signal, the pixel electrode is to be set to a higher voltage or a positive voltage before the negative transition. So, the transitions in the alternating voltage signal are at least partly anticipated, and a total voltage swing across the switching element is reduced. The switching element can now provide the larger voltage amplitudes across the pixel without having to handle voltages exceeding its ratings, thereby avoiding seriously degradation of its electrical characteristics.

In an embodiment the panel comprises a data electrode coupled to the data driving circuitry and coupled via switching elements to pixels in only one of the first and second portions. As a result, the first portion is for example coupled to the odd data electrodes, and the second portion is for example coupled to the even data electrodes. In this case, the first portion for example comprises all odd columns, and the second portion for example comprises all even columns, which allows the simultaneous driving, row for row, of all columns with information like the preset data pulses, which information remains advantageously constant for the entire frame.

In an embodiment of an electrophoretic display unit according to the invention the controller is adapted for controlling data driving circuitry to provide shaking data pulses, one or more reset data pulses, and one or more driving data pulses to the pixels. The shaking data pulses for example correspond with the preset data pulses discussed before. The reset data pulses precede the driving data pulses to further improve the optical response of the electrophoretic display unit, by defining a fixed starting point (fixed black or fixed white) for the driving data pulse. Alternatively, the reset data pulses precede the driving data pulses to further improve the optical response of the electrophoretic display unit, by defining a flexible starting point (black or white, to be selected in dependence of and closest to the gray value to be defined by the following driving data pulses) for the driving data pulses.

An embodiment of an electrophoretic display unit according to the invention is defined by first shaking data pulses being supplied to the first portion and second shaking data pulses being supplied to the second portion, which first and second shaking data pulses have opposite amplitudes. Especially for the shaking data pulses having increased amplitudes, the visibility of the disturbances need to be reduced.

An embodiment of an electrophoretic display unit according to the invention is defined by one or more first reset data pulses being supplied to the first portion and one or more second reset data pulses being supplied to the second portion, which first and second reset data pulses have opposite amplitudes. So, the invention is not limited to preset data pulses or shaking data pulses, but can be used as well for the reset data pulses. Further, in case of driving data pulses changing regularly for (a part of) the electrophoretic display unit, the invention can be used for (this part of the) electrophoretic display unit too.

The display device as claimed in claim 8 may be an electronic book, while the storage medium for storing information may be a memory stick, an integrated circuit, a memory like an optical or magnetic disc or other storage device for storing, for example, the content of a book to be displayed on the display unit.

Embodiments of a method according to the invention and of a processor program product according to the invention correspond with the embodiments of an electrophoretic display unit according to the invention.

The invention is based upon an insight, inter alia, that the visibility of disturbances need to be reduced, and is based upon a basic idea, inter alia, that different counter electrodes for different portions allow each portion to be controlled more individually than before, which results in disturbances being less visible.

The invention solves the problem, inter alia, of providing an electrophoretic display unit for relatively reducing the visibility of the disturbance, and is advantageous, inter alia, in that the introduction of different counter electrodes for different portions keeps the power consumption of the electrophoretic display unit at substantially the same level.

These and other aspects of the invention will be apparent from and elucidated with reference to the embodiments(s) described hereinafter.

In the drawings:

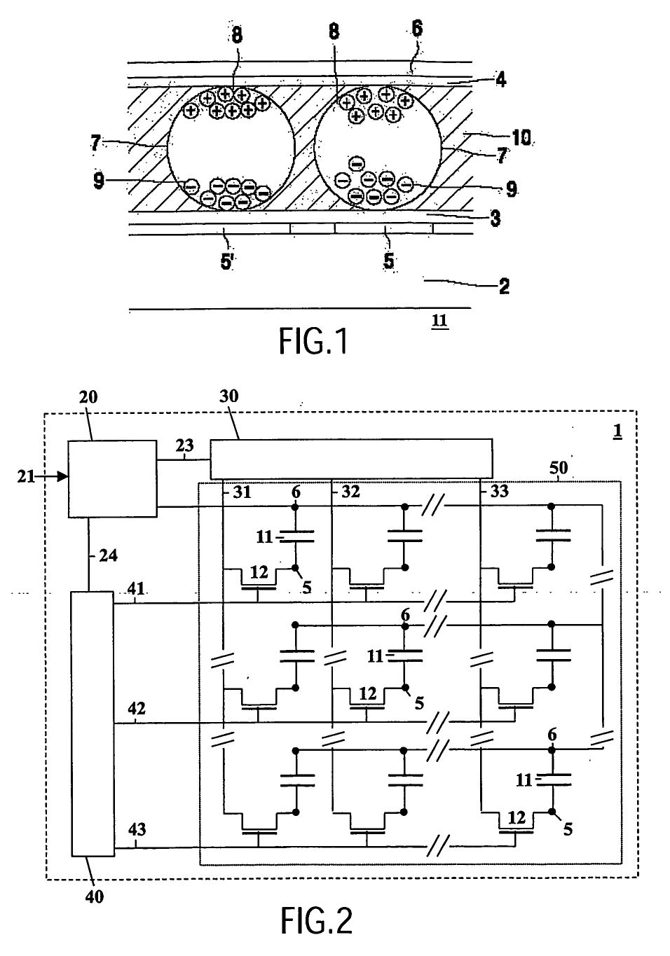

FIG. 1 shows (in cross-section) a pixel;

FIG. 2 shows diagrammatically a prior art electrophoretic display unit;

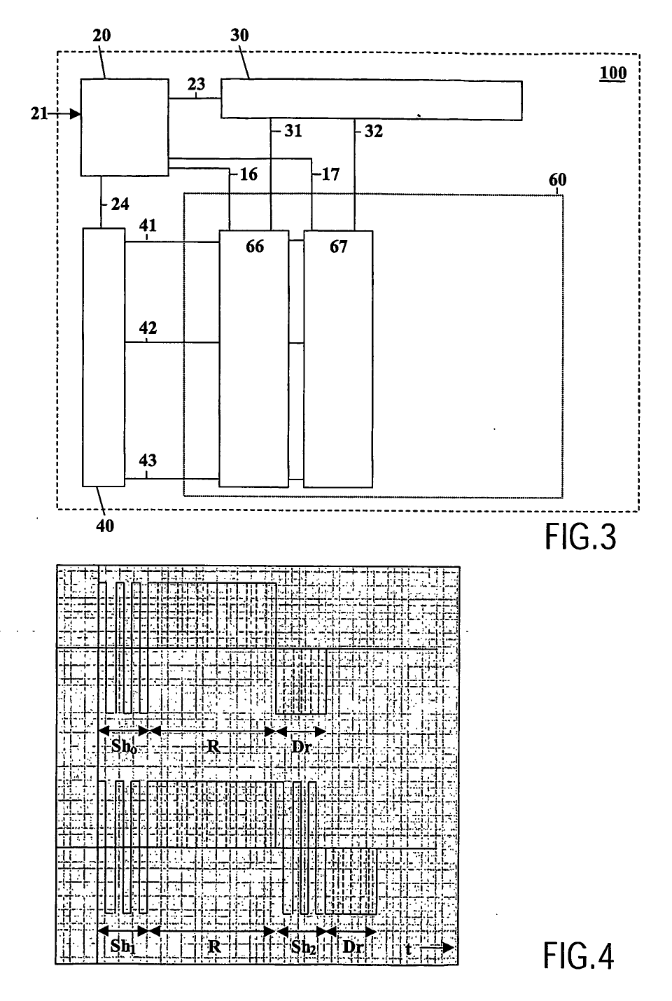

FIG. 3 shows diagrammatically an electrophoretic display unit according to the invention;

FIG. 4 shows shaking data pulses, reset data pulses and driving data pulses across a pixel;

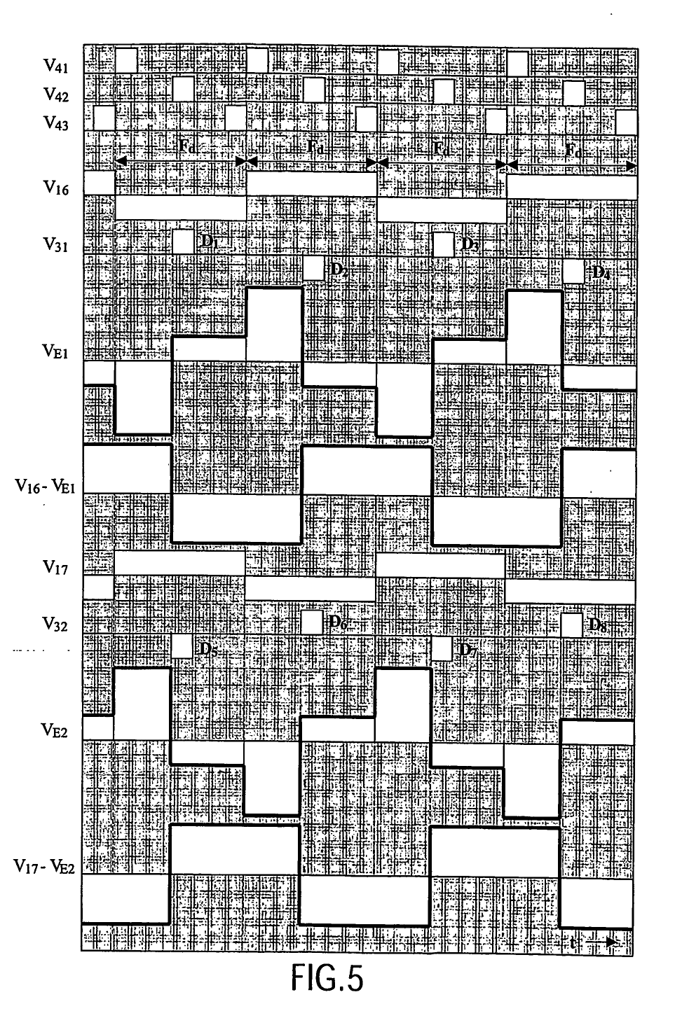

FIG. 5 shows voltages in an electrophoretic display unit according to the invention based upon driving frames; and

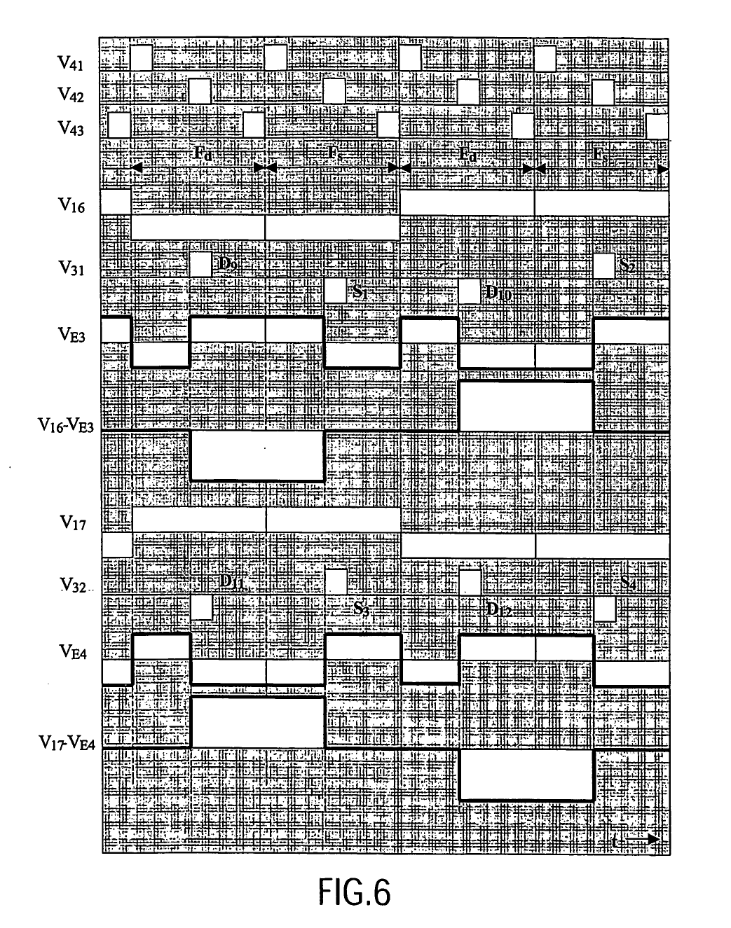

FIG. 6 shows voltages in an electrophoretic display unit according to the invention based upon driving frames and setting frames.

The pixel 11 of the electrophoretic display unit shown in FIG. 1 (in cross-section) comprises a base substrate 2, an electrophoretic film (laminated on base substrate 2) with an electronic ink, which is present between two transparent substrates 3,4 of, for example, polyethylene. One of the substrates 3 is provided with transparent pixel electrodes 5 and the other substrate 4 is provided with a transparent common electrode 6. The electronic ink comprises multiple microcapsules 7 of about 10 to 50 microns in diameter. Each microcapsule 7 comprises positively charged white particles 8 and negatively charged black particles 9 suspended in a fluid 10. When a positive voltage is applied to the pixel electrode 5, the white particles 8 move to the side of the microcapsule 7 directed to the common electrode 6, and the pixel becomes visible to a viewer. Simultaneously, the black particles 9 move to the opposite side of the microcapsule 7 where they are hidden from the viewer. By applying a negative voltage to the pixel electrode 5, the black particles 9 move to the side of the microcapsule 7 directed to the common electrode 6, and the pixel appears dark to a viewer (not shown). When the electric voltage is removed, the particles 8,9 remain in the acquired state and the display exhibits a bi-stable character and consumes substantially no power. In alternative systems, particles may move in an in-plane direction, driven by electrodes, which may be situated on the same substrate.

The electrophoretic display unit 1 shown in FIG. 2 comprises a display panel 50 comprising a matrix of pixels 11 at the area of crossings of row or selection electrodes 41,42,43 and column or data electrodes 31,32,33. These pixels 11 are all coupled to a common electrode 6, and each pixel 11 is coupled to its own pixel electrode 5. The electrophoretic display unit 1 further comprises selection driving circuitry 40 (row driver 40) coupled to the row electrodes 41,42,43 and data driving circuitry 30 (column driver 30) coupled to the column electrodes 31,32,33 and comprises per pixel 11 an active switching element 12. The electrophoretic display unit 1 is driven by these active switching elements 12 (in this example (thin-film) transistors). The selection driving circuitry 40 consecutively selects the row electrodes 41,42,43, while the data driving circuitry 30 provides data signals to the column electrode 31,32,33. Preferably, a controller 20 first processes incoming data arriving via input 21 and then generates the data signals. Mutual synchronisation between the data driving circuitry 30 and the selection driving circuitry 40 takes place via drive lines 23 and 24. Selection signals from the selection driving circuitry 40 select the pixel electrodes 5 via the transistors 12 of which the drain electrodes are electrically coupled to the pixel electrodes 5 and of which the gate electrodes are electrically coupled to the row electrodes 41,42,43 and of which the source electrodes are electrically coupled to the column electrodes 31,32,33. A data signal present at the column electrode 31,32,33 is simultaneously transferred to the pixel electrode 5 of the pixel 11 coupled to the drain electrode of the transistor 12. Instead of transistors, other switching elements can be used, such as diodes, MIMs, etc. The data signals and the selection signals together form (parts of) driving signals.

The controller may be formed by one or more integrated circuits, optionally with embedded software and/or additional components.

Incoming data, such as image information receivable via input 21 is processed by controller 20. Thereto, controller 20 detects an arrival of new image information about a new image and in response starts the processing of the image information received. This processing of image information may comprise the loading of the new image information, the comparing of previous images stored in a memory of controller 20 and the new image, the interaction with temperature sensors, the accessing of memories containing look-up tables of drive waveforms etc. Finally, controller 20 detects when this processing of the image information is ready.

Then, controller 20 generates the data signals to be supplied to data driving circuitry 30 via drive lines 23 and generates the selection signals to be supplied to row driver 40 via drive lines 24. These data signals comprise data-independent signals which are the same for all pixels 11 and data-dependent signals which may or may not vary per pixel 11. The data-independent signals comprise shaking data pulses forming the preset data pulses, with the data-dependent signals comprising one or more reset data pulses and one or more driving data pulses. These shaking data pulses comprise pulses representing energy which is sufficient to release the electrophoretic particles 8,9 from a static state at one of the two electrodes 5,6, but which is too low to allow the particles 8,9 to reach the other one of the electrodes 5,6. Because of the reduced dependency on the history, the optical response to identical data will be substantially equal, regardless of the history of the pixels 11. So, the shaking data pulses reduce the dependency of the optical response of the electrophoretic display unit on the history of the pixels 11. The reset data pulse precedes the driving data pulse to further improve the optical response, by defining a flexible starting point for the driving data pulse. This starting point may be a black or white level, to be selected in dependence on and closest to the gray value defined by the following driving data pulse. Alternatively, the reset data pulse may form part of the data-independent signals and may precede the driving data pulse to further improve the optical response of the electrophoretic display unit, by defining a fixed starting point for the driving data pulse. This starting point may be a fixed black or fixed white level.

To minimise the width of the data pulses without reducing the energy of the pulses, the height of the data pulses is to be increased, by adapting the standard data driving circuitry 30 or replacing this standard data driving circuitry 30, which is expensive, or by introducing a supply of a non-zero, alternating voltage signal to the common electrode 6. Thereto, when driving the pixels with positive data pulses, the common electrode 6 should be at a negative voltage level, and when driving the pixels with negative data pulses, the common electrode 6 should be at a positive voltage level. As a result, larger voltage amplitudes will be present across the pixels. However, for example, the shaking data pulses, when becoming of increased amplitude, become relatively visible as a flickering image. When the alternating amplitudes of the shaking data pulses increase, the disturbances resulting from the shaking data pulses become more visible. To reduce the visibility of the disturbances, different counter electrodes coupled to different portions of the panel are introduced, as shown in FIG. 3.

The electrophoretic display unit 100 shown in FIG. 3 comprises a display panel 60 which comprises a first portion 66 and a second portion 67. First portion 66 is coupled to data driving circuitry 30 via data electrode 31 and is coupled to a first counter electrode 16 further, for example, coupled to controller 20. Second portion 67 is coupled to data driving circuitry 30 via data electrode 32 and is coupled to a second counter electrode 17 further, for example, coupled to controller 20. Both portions are coupled via selection electrodes 41,42,43 to selection driving circuitry 40. Controller 20 has already been described for FIG. 2.

By introducing the first counter electrode 16 coupled to the first portion 66 comprising first pixels 11 and a second counter electrode 17 coupled to the second portion 67 comprising second pixels 11, instead of having one common electrode 6 for all pixels 11, the electrophoretic display unit 100 is divided into at least two portions 66,67, with each portion 66,67 having its own counter electrode 16,17. The different counter electrodes 16,17 for different portions 66,67 allow each portion 66,67 to be controlled more individually than before. As a result, instead of one kind of disturbance for the entire electrophoretic display unit 1, each portion 66,67 in electrophoretic display unit 100 has its own kind of disturbance. The average of several kinds of disturbances is less visible than each single kind of disturbance, resulting in the displaying of the disturbances being camouflaged.

The first portion 66, for example, comprises all odd columns, and the second portion 67, for example, comprises all even columns, which allows the simultaneous driving, row for row, of all columns with information like the shaking data pulses, which information remains advantageously constant for the entire frame. However, other and/or more kinds of portions are not to be excluded, like hexagonal portions and portions comprising odd and even rows etc. In addition, first and second counter electrodes may be situated on the same substrate as the pixel electrodes in systems where the particles move in an in-plane direction or situated on the substrate opposite to the pixel electrodes in systems where the particles move in an out of plane direction, or different counter electrodes may be situated on the same substrate or on the substrate opposite to the pixel electrodes.

In FIG. 4, two waveforms are shown for driving an electrophoretic display unit 1,100. A first waveform (upper graph) comprises shaking data pulses Sh₀, followed by a reset data pulse R and a driving data pulse Dr. A second waveform (lower graph) comprises shaking data pulses Sh₁, followed by a reset data pulse R, shaking data pulses Sh₂, and a driving data pulse Dr. For example for an electrophoretic display unit with four gray levels, sixteen different waveforms are stored in a memory (like for example a look-up table memory etc.) forming part of and/or coupled to controller 20. In response to data receiveable via input 21, controller 20 selects a waveform for one or more pixels 11, and supplies the corresponding selection signals and data signals via the corresponding driving circuitry 30,40 to the corresponding transistors 12 and the corresponding one or more pixels 11.

The voltages according to the invention in an electrophoretic display unit 100 according to the invention based upon driving frame periods F_{d} shown in FIG. 5 comprise selection pulses V₄₁, V₄₂, V₄₃ as present at row electrodes 41,42,43, a first alternating voltage signal V₁₆ as present at the first counter electrode 16, data pulses D₁,D₂,D₃,D₄ as present at column electrode 31, the voltage V_{E1} at a pixel electrode 5 of a pixel 11 in the first portion 66, the voltage V₁₆-V_{E1} being the voltage across the pixel 11, a second alternating voltage signal V₁₇ as present at the second counter electrode 17, data pulses D₅,D₆,D₇,D₈ as present at column electrode 32, the voltage V_{E2} at a pixel electrode 5 of a pixel 11 in the second portion 67, and the voltage V₁₇-V_{E2} across pixel 11 in the second portion, for four driving frame periods F_{d}.

The voltage V_{E1} has, before the start of the first frame F_{d}, an amplitude of, for example, −15 Volt, due to a previous data pulse for example being negative and having a negative amplitude of, for example, −15 Volt. Then, at the start of the first frame period F_{d}, the negative transition in the alternating voltage signal V₁₆ from, for example, +15 Volt to −15 Volt is passed to the pixel electrode 5 due to the capacitance of pixel 11. The voltage V_{E1} becomes 45 Volt. At this point in time the gate voltage of the transistor 12 is at the level of the voltage of the row electrode, being about 0 Volt. As a result, the transistor 12 starts conducting and discharges the capacitance of the pixel 11 until the voltage V_{E1} reaches this level of 0 Volt. This effect has not been shown in FIG. 5 in order to simplify the explanation of the waveforms. During a first selection pulse V₄₂ as present at row electrode 42, the first data pulse D₁ is supplied via a transistor 12 to pixel electrode 5 in a row corresponding with row electrode 42 and in a column corresponding with data electrode 31 and in first portion 66. As a result, the voltage V_{E1} at pixel electrode 5 becomes +15 Volt. At the start of the second frame period F_{d}, the positive transition in the alternating voltage signal V₁₆ from for example −15 Volt to +15 Volt is passed to the pixel electrode 5. The voltage V_{E1} becomes +45 Volt. During a second selection pulse V₄₂ as present at row electrode 42, the second data pulse D₂ is supplied via the transistor 12 to the pixel electrode 5. As a result, the voltage V_{E1} becomes −15 Volt. At the start of the third frame period F_{d}, the negative transition in the alternating voltage signal V₁₆ from for example +15 Volt to −15 Volt is passed to the electrode 5. The voltage V_{E1} becomes 45 Volt. During a third selection pulse V₄₂ as present at row electrode 42, the third data pulse D₃ is supplied via the transistor 12 to the pixel electrode 5. As a result, the voltage V_{E1} becomes +15 Volt. At the start of the fourth frame period F_{d}, the positive transition in the alternating voltage signal V₁₆ from for example −15 Volt to +15 Volt is passed to the pixel electrode 5. The voltage V_{E1} becomes +45 Volt. During a fourth selection pulse V₄₂ as present at row electrode 42, the fourth data pulse D₄ is supplied via the transistor 12 to the pixel electrode 5. As a result, the voltage V_{E1} becomes −15 Volt etc. As a result, the voltage V₁₆-V_{E1} across the pixel 11 in the first portion 66 is an alternating voltage signal with a doubled amplitude and, for example, corresponds with first shaking pulses Sh₀,Sh₁,Sh₂, shown in FIG. 4 for shaking the first portion 66.

The voltage V_{E2} has, before the start of the first frame F_{d}, an amplitude of, for example, +15 Volt, due to a previous data pulse, for example, being positive and having a positive amplitude of for example +15 Volt. Then, at the start of the first frame period F_{d}, the positive transition in the alternating voltage signal V₁₇ from for example −15 Volt to +15 Volt is passed to the pixel electrode 5 via the capacitance of pixel 11. The voltage V_{E2} becomes +45 Volt. During a first selection pulse V₄₂ as present at row electrode 42, the fifth data pulse D₅ is supplied via a transistor 12 to a pixel electrode 5 in a row corresponding with row electrode 42 and in a column corresponding with data electrode 32 and in second portion 67. As a result, the voltage V_{E2} becomes −15 Volt. At the start of the second frame period F_{d}, the negative transition in the alternating voltage signal V₁₇ from for example +15 Volt to −15 Volt is passed to the pixel electrode 5. The voltage V_{E2} becomes 45 Volt. During a second selection pulse V₄₂ as present at row electrode 42, the sixth data pulse D₆ is supplied via the transistor 12 to the pixel electrode 5. As a result, the voltage V_{E2} becomes +15 Volt. At the start of the third frame period F_{d}, the positive transition in the alternating voltage signal V₁₇ from for example −15 Volt to +15 Volt is passed to the voltage V_{E2}. The voltage V_{E2} becomes +45 Volt. During a third selection pulse V₄₂ as present at row electrode 42, the seventh data pulse D₇ is supplied via the transistor 12 to the pixel electrode 5. As a result, the voltage V_{E2} becomes −15 Volt. At the start of the fourth frame period F_{d}, the negative transition in the alternating voltage signal V₁₇ from for example +15 Volt to −15 Volt is passed to the pixel electrode 5. The voltage V_{E2} becomes −45 Volt. During a fourth selection pulse V₄₂ as present at row electrode 42, the eighth data pulse D₈ is supplied via the transistor 12 to the pixel electrode 5. As a result, the voltage V_{E2} becomes +15 Volt etc. As a result, the voltage V₁₇-V_{E2} across the pixel 11 in the second portion 67 is an alternating voltage signal with a doubled amplitude and, for example, corresponds with second shaking pulses Sh₀,Sh₁,Sh₂, shown in FIG. 4 for shaking the second portion 67.

The total voltage swing of the voltages V_{E1} and V_{E2} is about 90 Volt. Due to the gate of transistor 12 being coupled to ground, so being at zero Volt most of the time of the frame, this total voltage swing is also present across the drain-gate-junction of transistor 12, and may cause a breakdown of transistor 12. More precisely, the voltage difference present across the drain-gate-junction of transistor 12 corresponds with the V_{E1}, respectively V_{E2} minus V₄₂. As can be derived from FIG. 5, this voltage difference still has the voltage swing of about 90 Volt. Further, large voltage amplitudes during a short time are less likely to cause a breakdown of a transistor as large voltage amplitudes during a longer time. The duration of a selection pulse V₄₂ is, for example, about 1/1000 of the duration of a frame period F_{d}, so applying this relatively short pulse does not cause a breakdown of the transistor.

To reduce this large voltage swing, while keeping the double amplitudes for the voltage across the pixels 11, voltages in an electrophoretic display unit 100 according to the invention based upon driving frame periods F_{d} and setting frame periods Fₛ are shown in FIG. 6. These voltages comprise selection pulses V₄₁, V₄₂, V₄₃ across pixel 11 as present at row electrodes 41,42,43, a first alternating voltage signal V₁₆ as present at the first counter electrode 16, a first data pulse Dₛ, a first setting signal S₁, a second data pulse D₁₀, and a second setting signal S2 as present at column electrode 31, the voltage V_{E3} at a pixel electrode 5 in the first portion 66, the voltage V₁₆-V_{E3} across pixel 11, a second alternating voltage signal V₁₇ as present at the second counter electrode 17, a third data pulse D₁₁, a third setting signal S3, a fourth data pulse D₁₂, and a fourth setting signal S4 as present at column electrode 32, the voltage V_{E4} at a pixel electrode 5 in the second portion 67, the voltage V₁₇-V_{E4}, for a first driving frame period F_{d}, a first setting frame period Fₛ, a second driving frame period F_{d}, and a second setting frame period Fₛ.

The voltage V_{E3} has, before the start of the first driving frame period F_{d}, an amplitude of for example +15 Volt, due to a previous setting pulse for example being positive and having a positive amplitude of for example +15 Volt. Then, at the start of the first driving frame period F_{d}, the negative transition of the alternating voltage signal V₁₆ from, for example, +15 Volt to −15 Volt is passed to the pixel electrode 5 due to an electrical equivalence of a pixel 11 comprising a capacitance. The voltage V_{E3} becomes −15 Volt. During a first selection pulse V₄₂ as present at row electrode 42, the first data pulse D₉ is supplied via a transistor 12 to a pixel electrode 5 in a row corresponding with the row electrode 42 and in a column corresponding with the data electrode 31 in the first portion 66. As a result, the voltage V_{E3} becomes +15 Volt. At the start of the first setting frame period Fₛ, there is no transition in the alternating voltage signal V₁₆ and the voltage V_{E3} remains +15 Volt. During a second selection pulse V₄₂ as present at row electrode 42, the first setting signal S₁ is supplied via transistor 12 to pixel electrode 5. As a result, the voltage V_{E3} becomes −15 Volt. At the start of the second driving frame period F_{d}, the positive transition in the alternating voltage signal V₁₆ from, for example, −15 Volt to +15 Volt is passed to the pixel electrode 5. The voltage V_{E3} becomes +15 Volt. During a third selection pulse V₄₂ as present at row electrode 42, the second data pulse D₁₀ is supplied via transistor 12 to pixel electrode 5. As a result, the voltage V_{E3} becomes −15 Volt. At the start of the second setting frame period Fₛ, there is no transition in the alternating voltage signal V₁₆ and the voltage V_{E3} remains −15 Volt. During a fourth selection pulse V₄₂ as present at row electrode 42, the second setting signal S2 is supplied via transistor 12 to pixel electrode S. As a result, the voltage V_{E3} becomes +15 Volt etc. As a result, the voltage V₁₆-V_{E3} across the pixel 11 in the first portion 66 is an alternating voltage signal with a doubled amplitude and for example corresponds with first shaking pulses Sh₀,Sh₁,Sh₂, shown in FIG. 4 for shaking the first portion 66, which first shaking pulses however now have an intermediate value when going from one extreme value to the other.

The voltage V_{E4} has, before the start of the first driving frame period F_{d}, an amplitude of for example −15 Volt, due to a previous setting pulse, for example, being negative and having a negative amplitude of for example −15 Volt. Then, at the start of the first driving frame period F_{d}, the positive transition in the alternating voltage signal V₁₇ from for example −15 Volt to +15 Volt is passed to the voltage V_{E4} due to an electrical equivalence of a pixel 11 comprising a capacitance. The voltage V_{E4} becomes +15 Volt. During a first selection pulse V₄₂ as present at row electrode 42, the third data pulse D₁₁ is supplied via a transistor 12 to a pixel electrode 5 in a row corresponding with the row electrode 42 and in a column corresponding with the data electrode 31 in the second portion 67. As a result, the voltage V_{E4} becomes −15 Volt. At the start of the first setting frame period Fₛ, there is no transition in the alternating voltage signal V₁₇ and the voltage V_{E4} remains −15 Volt. During a second selection pulse V₄₂ as present at row electrode 42, the third setting signal S₃ is supplied via transistor 12 to pixel electrode 5. As a result, the voltage V_{E4} becomes +15 Volt. At the start of the second driving frame period F_{d}, the negative transition in the alternating voltage signal V₁₇ from for example +15 Volt to −15 Volt is passed to the pixel electrode 5. The voltage V_{E4} becomes −15 Volt. During a third selection pulse V₄₂ as present at row electrode 42, the fourth data pulse D₁₂ is supplied via transistor 12 to pixel electrode 5. As a result, the voltage V_{E4} becomes +15 Volt. At the start of the second setting frame Fₛ, there is no transition in the alternating voltage signal V₁₇ and the voltage V_{E4} remains +15 Volt. During a fourth selection pulse V₄₂ as present at row electrode 42, the fourth setting signal S₄ is supplied via transistor 12 to pixel electrode 5. As a result, the voltage V_{E4} becomes −15 Volt etc. As a result, the voltage V₁₇-V_{E4} across the pixel 11 in the second portion 67 is an alternating voltage signal with a doubled amplitude and for example corresponds with second shaking pulses Sh₀,Sh₁,Sh₂, shown in FIG. 4 for shaking the second portion 67, which second shaking pulses however now show an intermediate value when going from one extreme value to the other.

The total voltage swing in the voltage V_{E3} and V_{E4} is about 30 Volt. Due to the gate of transistor 12 being coupled to ground, so being zero Volt most of the frame period, this total voltage swing is also present across the drain-gate-junction of transistor 12, and does not endanger transistor 12. More precisely, the voltage difference present across the drain-gate-junction of transistor 12 corresponds with the V_{E3}, respectively V_{E4} minus V₄₂. As can be derived from FIG. 6, this voltage difference may become 30 Volt, but only during a very short time, and this does not endanger the transistor 12 as much as the voltage swing of about 90 Volt. As described before, the duration of a selection pulse V₄₂ is for example about 1/1000 of the duration of a frame period Fd.

It should be noted that FIGS. 5 and 6 just show the voltages for two pixels 11 in a row corresponding with row electrode 42 and in columns corresponding with data electrodes 31 and 32. The setting signal S₁,S₂ (S₃,S₄) at data electrode 31 (32) is supplied to the source of the transistor 12 and becomes, at the drain of the transistor 12, a setting pulse S₁,S₂ (S₃,S₄), due to the transistor 12 being brought in a conductive state in response to and only during the supply of a selection pulse. However, in practice, via data electrode 31 (32) all data pulses and all setting signals are supplied for all pixels 11 in the same column subsequently. This would make the FIG. 4 much more complicated, and therefore, for the sake of clarity, only for two pixels 11, the voltages according to the invention have been shown. Independent of the complexity shown, the principle of course remains the same.

Preferably, the setting frame period Fₛ is shorter than the driving frame period F_{d}, to minimise the reduction of the driving speed and the increase of the image update time resulting from the introduction of the setting frame period Fₛ. compared to reduction of the total image update time resulting from the increased voltage amplitudes across the pixel 11, the increase of the image update time resulting from the introduction of the setting frame period Fₛ is negligible.

The use of higher voltages allows some advantageous options. According to a first advantageous option, a high voltage reset signal can be generated. As the (over) reset is one of the longest parts of a rail stabilised drive scheme, it is especially advantageous to reduce the time of the reset.

According to a second advantageous option, a high voltage shaking signal can be generated. Shaking is a key component of all drive schemes, so it is always advantageous to reduce the time of the shaking pulses.

In particular, the invention can be advantageously applied to systems driven with variable amplitude voltages.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An electrophoretic display unit (100) comprising:
an electrophoretic display panel (60) comprising pixels (11);
a first counter electrode (16) coupled to pixels (11) in a first portion (66) of the electrophoretic display panel (60);
a second counter electrode (17) coupled to pixels (11) in a second portion (67) of the electrophoretic display panel (60), and
a controller (20) for controlling a supply of a first signal (V₁₆) to the first counter electrode (16) and a supply of a second signal (V₁₇) different from said first voltage signal (V₁₆), to the second counter electrode (17).

2. An electrophoretic display unit (100) as defined in claim 1, wherein the first and second signals (V₁₆, V₁₇) are alternating voltage signals having substantially opposite phases.

3. An electrophoretic display unit (100) as defined in claim 1, further comprising data driving circuitry (30) for supplying a data pulse (D₁-D₁₂) to a pixel electrode (5) of a pixel (11) via a switching element,
the controller (20) being adapted to control the data driving circuitry (30) for supplying a setting signal (S₁-S₄) to the pixel electrode (5) for reducing a voltage across the pixel (11) before a transition of at least one of the first and second voltage signals (V₁₆, V₁₇).

4. An electrophoretic display unit (100) as defined in claim 1, the panel (60) comprising a data electrode (31, 32, 33) coupled to the data driving circuitry (30) and coupled via switching elements to pixels (11) in only one of the first and second portions (66, 67).

5. An electrophoretic display unit (100) as defined in claim 1, the controller (20) being adapted for controlling data driving circuitry (30) to provide:
shaking data pulses (Sh₀,Sh₁,Sh₂);
one or more reset data pulses (R); and
one or more driving data pulses (Dr);
to the pixels (11).

6. An electrophoretic display unit (100) as defined in claim 5, the controller (20) being adapted for controlling the data driving circuitry (30) to provide first shaking data pulses (V₁₆-V_{E1}, V₁₆-V_{E3}) to the first portion (66) and second shaking data pulses (V₁₇-V_{E2}, V₁₇-V_{E4}) to the second portion (67), the first and second shaking data pulses having substantially opposite amplitudes.

7. An electrophoretic display unit (100) as defined in claim 5, the controller (20) being adapted for controlling the data driving circuitry (30) to provide one or more first reset data pulses to the first portion (66) and one or more second reset data pulses to the second portion (67), the first and second reset data pulses having substantially opposite amplitudes.

8. A display device comprising an electrophoretic display unit (100) as defined in claim 1; and comprising a storage medium for storing information to be displayed.

9. A method for driving an electrophoretic display unit (100) comprising an electrophoretic display panel (50,60) which comprises pixels (11), a first counter electrode (16) coupled to pixels (11) in a first portion (66) of the electrophoretic display panel (60), and a second counter electrode (17) coupled to pixels (11) in a second portion (67) of the electrophoretic display panel (60),
the method comprising the steps of supplying a first signal (V₁₆) to the first counter electrode (16) and a second signal (V₁₇), different from the first signal (16), to the second counter electrode (17).

10. A processor program product for driving an electrophoretic display unit (100) comprising pixels (11), a first counter electrode (16) for a first portion (66) of the electrophoretic display panel (60), and a second counter electrode (17) for a second portion (67) of the electrophoretic display panel (60), the processor program product comprising the functions of supplying a first signal (V₁₆) to the first counter electrode (16) and a second signal (V₁₇), different from the first signal (V₁₆), to the second counter electrode (17).

11. A controller for an electrophoretic display unit (100) comprising:
an electrophoretic display panel (60) comprising pixels (11),
a first counter electrode (16) coupled to pixels (11) in a first portion (66) of the electrophoretic display panel (60),
a second counter electrode (17) coupled to pixels (11) in a second portion (67) of the electrophoretic display panel (60),
the controller (20) being adapted for controlling a supply of a first signal (V₁₆) to the first counter electrode (16) and a supply of a second signal (V₁₇) different from said first voltage signal (V₁₆), to the second counter electrode (17).
